(19) United States
(12) Patent Application Publication
(10) Pub. No.: US 2021/0075923 A1
(43) Pub. Date: Mar. 11, 2021

(54) DATA TRANSMISSION APPARATUS, AND CONTROL METHOD THEREOF

(71) Applicant: CANON KABUSHIKI KAISHA, Tokyo (JP)

(72) Inventor: Masashi Nishiyama, Toride-shi (JP)

(21) Appl. No.: 17/007,271

(22) Filed: Aug. 31, 2020

(30) Foreign Application Priority Data
Sep. 6, 2019 (JP) 2019-163278

(51) Int. Cl. H04N 1/00; H04L 29/12; H04L 29/08

(52) U.S. Cl. CPC H04N 1/00395; H04L 61/1594; H04N 1/0022; H04L 67/10; H04L 67/02

(57) ABSTRACT

A data transmission apparatus including a plurality of transmission functions, comprises: a holding unit configured to hold an address book; a communication unit configured to communicate with a plurality of management servers; a first management unit configured to manage each of the plurality of transmission functions in association with an address book available in data transmission; a second management unit configured to manage, for each of the plurality of transmission functions, a setting of whether a new destination is registrable with the address book held by the holding unit; and a providing unit configured to provide a registration screen for registering the new destination with an address book. The registration screen switches address books as a registration destination based on information managed by the first and second management units, and receives an input of the new destination.

### BACKGROUND OF THE INVENTION

### Field of the Invention

The present invention relates to a data transmission apparatus, and a control method thereof.

### Description of the Related Art

In recent years, an address book cloud service for managing various kinds of destination data has been provided on the Internet (hereinafter referred to as a cloud address book). There has been proposed a technique in which an information processing apparatus such as a multifunction peripheral refers to information in a plurality of cloud address books, merges the information, and shows the information in a unified manner (e.g., Japanese Patent Laid-Open No. 2018-152833 (Patent Literature 1)). Accordingly, even when each cloud address book has a different UI (User Interface), an address book UI of the information processing apparatus can be used as a portal to refer to destination data of each cloud address book with the same operability.

However, in the method disclosed in Patent Literature 1, registration of data with the cloud address book by using the address book UI of the information processing apparatus is not considered. In a case where desired destination data does not exist when the address book is used, the destination data is generally registered immediately in situ. However, in the method described in Patent Literature 1, in a case where destination data is registered with the cloud address book while the address book UI of the information processing apparatus is used, work of separately starting a UI of the cloud address book and registering the destination data by using the UI is generated. Therefore, the method has poor usability for a user.

### SUMMARY OF THE INVENTION

According to one aspect of the present invention, a data transmission apparatus including a plurality of transmission functions each performing data transmission by using a different protocol, the data transmission apparatus comprises: a holding unit configured to hold an address book; a communication unit configured to communicate with a plurality of management servers each managing a different address book; a first management unit configured to manage each of the plurality of transmission functions in association with an address book available in data transmission among the address book held by the holding unit and the address books each provided by each of the plurality of management servers; a second management unit configured to manage, for each of the plurality of transmission functions, a setting of whether a new destination is registrable with the address book held by the holding unit; a providing unit configured to provide a registration screen for registering the new destination with an address book; and a registration unit configured to perform registration processing of the new destination based on information input in the registration screen, wherein the registration screen switches address books as a registration destination, based on information managed by the first management unit and the second management unit, and receives an input of the new destination.

The present invention registers data with a plurality of address book services by using an address book screen of an information processing apparatus as a portal.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view illustrating an example of a system configuration according to an embodiment of the present invention.

FIG. 2 is a view illustrating an example of a hardware configuration of an information processing apparatus according to the present invention.

FIG. 3 is a view illustrating an example of a functional configuration of an information processing apparatus according to a first embodiment.

FIG. 4 is a view illustrating a configuration example of various kinds of data according to an embodiment of the present invention.

FIG. 5 is a view illustrating an example of a UI screen according to the first embodiment.

FIG. 6 is a flowchart of processing by the information processing apparatus according to the first embodiment.

FIG. 7 is a view illustrating an example of a functional configuration of an information processing apparatus according to a second embodiment.

FIG. 8 is a view illustrating a configuration example of various kinds of data according to the second embodiment.

FIG. 9 is a view illustrating an example of a UI screen according to the second embodiment.

FIG. 10 is a flowchart of processing by the information processing apparatus according to the second embodiment.

### DESCRIPTION OF THE EMBODIMENTS

Hereinafter, embodiments will be described in detail with reference to the accompanying drawings. The following embodiments do not limit the invention according to the claims. Although a plurality of features are described in the embodiments, some of the plurality of features may not be essential for the invention, and the plurality of features may be appropriately combined. Further, in the accompanying drawings, identical or similar configurations are denoted by identical reference numbers, and duplicate description will be omitted.

### First Embodiment

### System Configuration

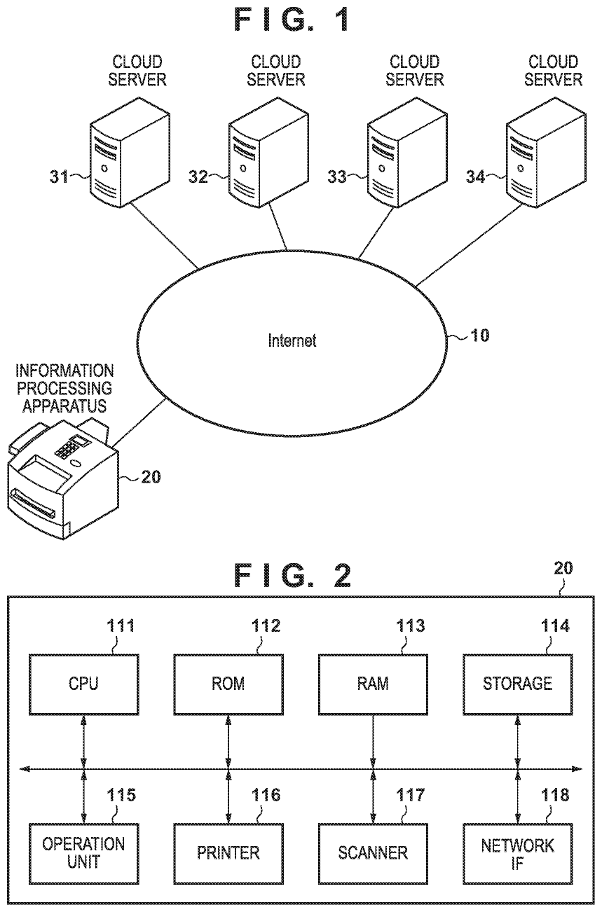

FIG. 1 is a view illustrating an example of a system configuration according to the present embodiment. An information processing apparatus 20 and cloud servers 31 to 34 are communicably connected via the Internet 10. In the present embodiment, the information processing apparatus 20 will be described as an image forming apparatus such as a multifunction peripheral, but the present invention is not limited to this. The information processing apparatus 20 functions as a data transmission apparatus including a plurality of transmission functions. Examples of the transmission functions include mail, fax, Server Message Block (SMB), File Transfer Protocol (FTP), Web-based Distributed Authoring and Versioning (WebDAV), and a transmission function to a cloud storage service.

Each of the cloud servers 31 to 34 is a management server that provides a service for managing an address book on the Internet 10. Each of the cloud servers 31 to 34 can be realized by one or more computers. In response to a request from a client (e.g., the information processing apparatus 20), the cloud servers 31 to 34 additionally register destination data with an address book to be managed, and provide the destination data to the client. In the present embodiment, the case where the cloud servers 31 to 34 are provided as different cloud services will be described as an example, but the present embodiment is not limited to this case. Additionally, in the present example, 4 cloud servers are described as an example, but the present embodiment is not limited to this.

Hardware Configuration

FIG. 2 is a view illustrating an example of a hardware configuration of the information processing apparatus 20 according to the present embodiment. A Central Processing Unit (CPU) 111 reads out a control program stored in a Read Only Memory (ROM) 112 or a storage 114 and performs various kinds of control such as reading control and transmitting control. The ROM 112 is a nonvolatile storage area and stores various programs. A random access memory (RAM) 113 is a main storage memory of the CPU 111, and is used as a work area or a temporary storage area for deploying a control program stored in the storage 114. The storage 114 stores image data, various programs, various kinds of history information, and various kinds of setting information. An operation unit 115 includes a liquid crystal display unit including a touch panel function, a keyboard, or the like, and functions as a receiving unit that receives an instruction from a user, and as a display unit that displays information to a user.

A printer 116 prints an image based on image data on a recording medium such as paper. A scanner 117 reads an image in a document placed in a document mounting section (not illustrated) of an Auto Document Feeder (ADF) or an image in a document placed on a platen glass (not illustrated) to generate image data. A network IF 118 is an interface for performing network communication with other apparatus. The respective units in the information processing apparatus 20 are communicably connected to each other by using an internal bus or the like.

Functional Configuration

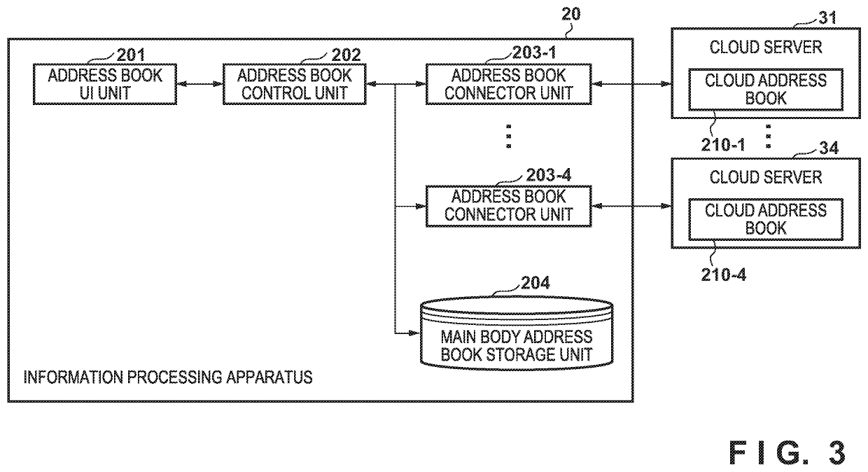

FIG. 3 is a view illustrating an example of a functional configuration of the information processing apparatus 20 according to the present embodiment. Each functional configuration is realized by, for example, the CPU 111 that reads out and executes a program stored in the storage 114 or the like. As illustrated in FIG. 3, the information processing apparatus 20 includes an address book UI unit 201, an address book control unit 202, address book connector units 203-1 to 203-4, and a main body address book storage unit 204. The address book UI unit 201 displays a UI for operating an address book in the operation unit 115, and receives an instruction operated via the UI. The address book UI unit 201 acquires destination data to be displayed in the UI from the address book control unit 202. The address book UI unit 201 receives a registration request from the operation unit 115, and issues a registration request to the address book control unit 202. The address book control unit 202 controls a main body address book provided in the information processing apparatus 20 and an address book (here, a cloud address book) provided in an external apparatus.

Each of the address book connector units 203-1 to 203-4 is a unit for connecting to an address book provided in an external apparatus. In the present embodiment, four address book connector units 203 respectively corresponding to cloud servers 31 to 34 will be described as an example. In the following description, in a case where contents common to the address book connector units 203 are described, the description will be made with the subscript omitted, and in a case where a separate description is required, the description will be made with the subscript added. The main body address book storage unit 204 is a database that stores the main body address book managed by the information processing apparatus 20, and can be realized by, for example, the storage 114.

The cloud servers 31 to 34 include cloud address books 210-1 to 210-4 respectively managed by the respective servers. In the following description, in a case where contents common to the cloud address books 210 are described, the description will be made with the subscript omitted, and in a case where a separate description is required, the description will be made with the subscript added. The information processing apparatus 20 according to the present embodiment refers to and uses an available address book from among the main body address book provided in the information processing apparatus 20 and the cloud address books 210 provided in the cloud servers 31 to 34, according to a data transmission function (protocol) of the information processing apparatus 20.

Address Book

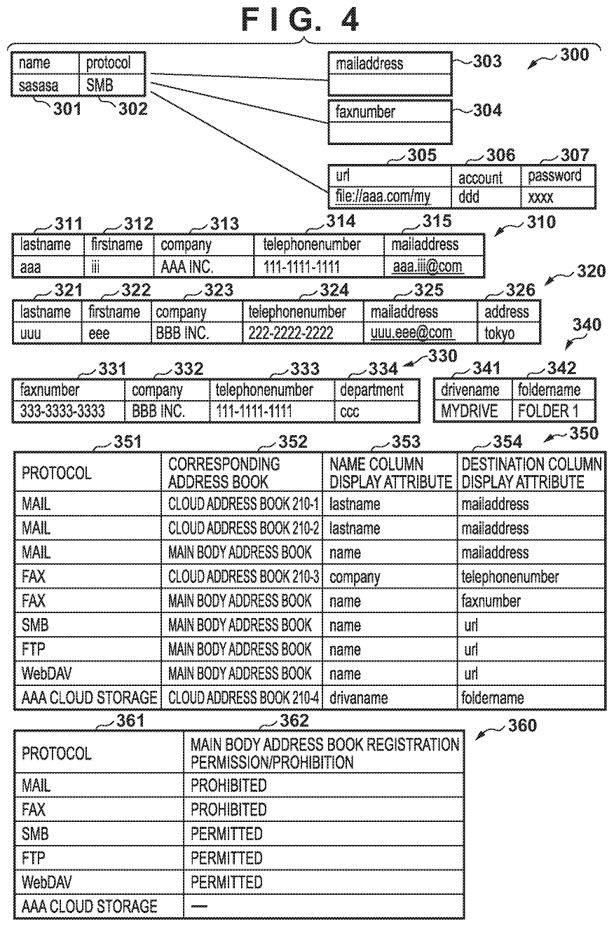

FIG. 4 is a view illustrating an example of a specification (data management format) of each address book according to the present embodiment.

A main body address book specification 300 indicates an example of a data management format of the main body address book managed by the main body address book storage unit 204 of the information processing apparatus 20. The main body address book specification 300 includes a name 301 indicating a name of destination data and a protocol 302 indicating a protocol type. A user may set an arbitrary value in the name 301. Examples of the protocol 302 include mail, fax, SMB, FTP, and WebDAV. The main body address book specification 300 further holds data corresponding to the protocol type. In a case where the protocol 302 is mail, a mailaddress 303 indicating an e-mail address is further provided. In a case where the protocol 302 is fax, a faxnumber 304 indicating a fax number is further provided. In a case where the protocol 302 is SMB, FTP, or WebDAV, a url 305, an account 306, and a password 307 are further provided. This is an example of a data management format for holding a destination of a transmission function of a multifunction peripheral.

A cloud address book specification 310 is an example of a data management format managed by the cloud address book 210-1 of the cloud server 31. The cloud address book specification 310 includes a lastname 311 and a firstname 312 indicating a name of a person, a company 313 indicating a company name, a telephonenumber 314 indicating a telephone number, and a mailaddress 315 indicating an e-mail address. This is an example of a data management format for mainly managing an e-mail address as personal contact.

A cloud address book specification 320 is an example of a data management format managed by the cloud address book 210-2 of the cloud server 32. The cloud address book specification 320 includes an address 326 indicating an address in addition to the information of the cloud address book specification 310. As with the cloud address book specification 310, this is an example of a data management format for mainly managing an e-mail address as personal contact.

A cloud address book specification 330 is an example of a data management format managed by the cloud address book 210-3 of the cloud server 33. The cloud address book specification 330 includes a faxnumber 331 indicating a fax number, a company 332 indicating a company name, a telephonenumber 333 indicating a telephone number, and a department 334 indicating a department. This is an example of a data management format for mainly managing a fax number as contact of a business partner.

A cloud address book specification 340 is an example of a data management format managed by the cloud address book 210-4 of the cloud server 34. The cloud address book specification 340 includes a drivename 341 indicating a drive name of virtual storage and a foldername 342 indicating a folder name in drive. This is an example of a data management format for mainly holding a storage location on a cloud storage service.

The address book connector units 203-1 to 203-4 of the information processing apparatus 20 illustrated in FIG. 3 are components created based on the cloud address book specifications 310, 320, 330, and 340, respectively. Each component supports the address book control unit 202 and the address book UI unit 201 to display a screen specialized for the cloud address book specification and to acquire and register data.

An address book correspondence table 350 is an example of the address book correspondence table 350 for each protocol managed by the address book control unit 202 of the information processing apparatus 20. As described above, the information processing apparatus 20 includes the address book connector units 203-1 to 203-4 in addition to the main body address book. Accordingly, the information processing apparatus 20 can manage (acquire and register) destination data of the cloud address books 210-1 to 210-4 provided in the cloud servers 31 to 34, respectively. The address book correspondence table 350 indicates which address book corresponds to a type of a transmission function of the information processing apparatus 20. The address book correspondence table 350 includes a protocol 351 indicating a type of a transmission function and a corresponding address book 352 indicating which address book each protocol corresponds to. Further, the address book correspondence table 350 includes a name column display attribute 353 indicating which attribute value of each address book is displayed in a name column of an address book screen. Further, the address book correspondence table 350 includes a destination column display attribute 354 indicating which attribute value of each address book is displayed in a destination column of an address book screen. In this embodiment, the address book correspondence table 350 can be used to collectively display data of the main body address book and each cloud address book in one address book screen. Further, in the case of registering destination data in the address book screen, it is possible to determine with which address book the destination data is registrable based on information of the address book correspondence table 350.

A registration prohibition table 360 is an example of a registration prohibition table in the main body address book managed by the address book control unit 202. Depending on an office environment of a user of the information processing apparatus 20, it may be desired to collectively manage all address books at the side of the cloud address books 210. The registration prohibition table 360 is used in accordance with this usage. The registration prohibition table 360 includes a protocol 361 and a main body address book registration permission/prohibition 362 indicating whether registration with the main body address book is permitted or prohibited for each protocol.

For example, in a case where it is desired to collectively manage a mail address at the side of certain cloud address book of the cloud address books 210 for security reasons, a value of the main body address book registration permission/prohibition 362 column of a row in which the protocol 361 is a “mail” is set as “prohibited.” Additionally, in general, a detailed setting for adjusting the operation for each protocol is required. For example, in the case of FTP, an example of the detailed setting includes a setting of a communication mode to an active mode or a passive mode. As one of the detailed settings for respective protocols, whether or not registration to the main body address book is prohibited may be settable. Additionally, a method of registering the detailed setting of the protocol is not particularly limited. For example, examples of this method include registration from a Web interface (e.g., operation from a Web browser provided in a PC on a network), registration by using the operation unit 115, and data distribution by a server.

Address Book Screen

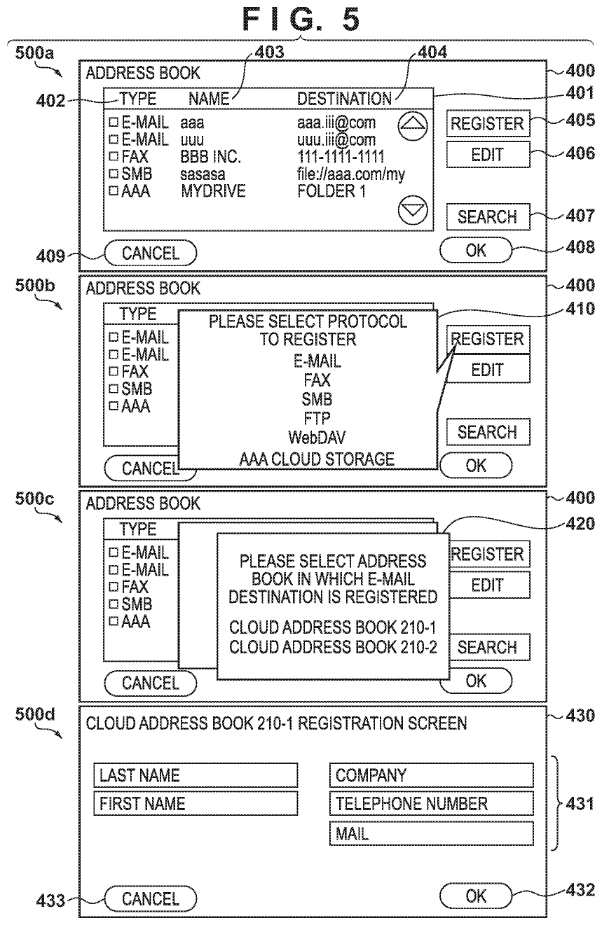

FIG. 5 illustrates an example of an address book screen as a UI screen displayed in the operation unit 115 by the address book UI unit 201 of the information processing apparatus 20 according to the present embodiment. An address book screen 400 indicated in a UI screen 500a includes a destination list 401, a registration button 405, an edit button 406, a search button 407, an OK button 408, and a cancel button 409. The destination list 401 is displayed based on information obtained by the address book control unit 202 from each address book (the cloud servers 31 to 34 or the main body address book storage unit 204). Destination data displayed in the destination list 401 includes columns of a type 402, a name 403, and a destination 404. Information displayed in these columns is based on correspondence indicated in the address book correspondence table 350.

The registration button 405 is pressed in the case of registering new destination data. In the case of editing destination data registered with the address book, the edit button 406 is pressed after target destination data is selected from the destination list 401. The search button 407 is pressed in the case of searching for destination data matching an arbitrary search condition in destination data registered with the address book. When the search button 407 is pressed, an input screen (not illustrated) for inputting search conditions is displayed. The OK button 408 is pressed after target destination data is selected from the destination list 401, and thus a transmission destination is determined. The cancel button 409 is pressed in the case of canceling selection of a destination using the address book.

When the registration button 405 is pressed, a selection screen 410 indicated in a UI screen 500b is displayed. On the selection screen 410, a user can select a protocol to be registered. When a protocol to be registered is selected in the selection screen 410, a selection screen 420 indicated in a UI screen 500c is displayed. Here, an example of a case where “E-mail” is selected in the selection screen 410 is indicated as the selection screen 420. In the selection screen 420, a user can select a registration destination address book used in the case of registering an e-mail destination.

The registration destination address book displayed in the selection screen 420 is displayed based on the address book correspondence table 350 and the registration prohibition table 360. An example of the selection screen 420 is displayed based on the following determination. In the example of the address book correspondence table 350, the cloud address books 210-1 and 210-2 and the main body address book are defined as e-mail correspondence address books. On the other hand, in the example of the registration prohibition table 360, registration of e-mail with the main body address book is prohibited. Thus, as indicated in the UI screen 500c, the main body address book is not displayed as a selection candidate in the selection screen 420, and the cloud address books 210-1 and 210-2 are selectably displayed in the selection screen 420.

A registration screen 430 indicated in a UI screen 500d is an example of a screen for registration with the cloud address book 210-1, which is displayed in a case where the “cloud address book 210-1” is selected in the selection screen 420 indicated in the UI screen 500c. The registration screen 430 includes screen contents configured based on the cloud address book specification 310. That is, an input unit 431 displays an input item corresponding to each item of the cloud address book specification 310. An OK button 432 is pressed in the case of registering information input to the input unit 431 as destination data. A cancel button 433 is pressed in the case of canceling registration of destination data. Note that as with the registration screen 430, an edit screen (not illustrated) displayed in a case where the edit button 406 is pressed may include screen contents configured corresponding to destination data selected in the destination list 401 based on the cloud address book specification 310.

Processing Flow

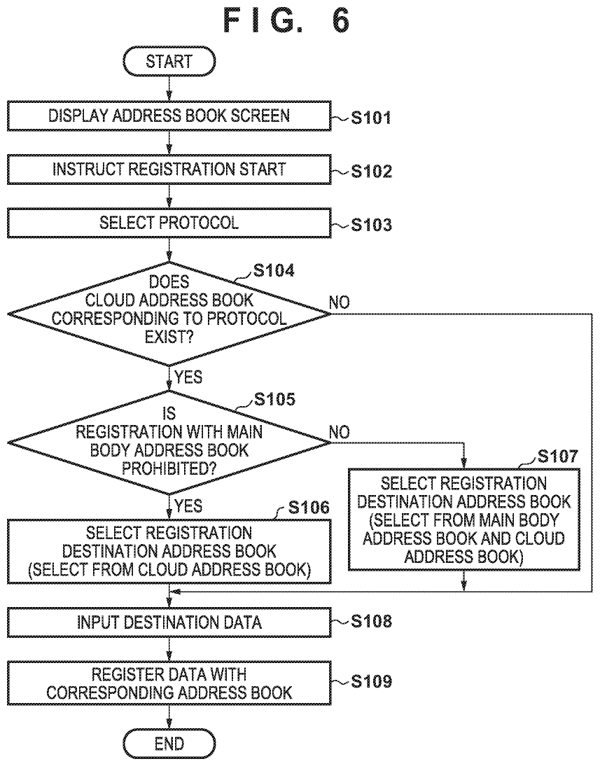

FIG. 6 is a flowchart explaining an operation performed in the case of registering destination data in the information processing apparatus 20 according to the present embodiment. This processing flow is realized by, for example, the CPU 111 of the information processing apparatus 20 that reads out and executes a program stored in the storage 114 or the like.

At S101, the address book UI unit 201 displays the address book screen 400 in the operation unit 115 in response to an instruction from a user. For example, the instruction may be issued by pressing a predetermined button or the like in the operation unit 115 of the information processing apparatus 20.

At S102, the address book UI unit 201 receives an instruction to register destination data from the user. This corresponds to the user that has pressed the registration button 405 in the address book screen 400.

At S103, the address book UI unit 201 receives a protocol selection instruction from the user. This corresponds to the user that has performed a protocol selection operation in the selection screen 410.

At S104, the address book control unit 202 determines whether a cloud address book corresponding to the protocol selected in the selection screen 410 exists. Here, the address book control unit 202 determines whether the cloud address book exists based on the address book correspondence table 350. In a case where the cloud address book corresponding to the selected protocol exists (YES at S104), the processing proceeds to S105, and in a case where the cloud address book corresponding to the selected protocol does not exist (NO at S104), the processing proceeds to S108. At this time, in a case where there is no corresponding cloud address book, registration with the main body address book is necessarily performed, and thus the processing proceeds to S108 without displaying the address book selection screen 420.

At S105, the address book control unit 202 determines whether registration with the main body address book is prohibited based on the registration prohibition table 360. In a case where registration with the main body address book is prohibited (YES at S105), the processing proceeds to S106, and in a case where registration with the main body address book is not prohibited (NO at S105), the processing proceeds to S107.

At S106, the address book UI unit 201 displays a list of corresponding cloud address books in the selection screen 420, and receives from the user a selection of with which cloud address book registration is performed. Then, after selection of an address book as a registration destination is received, the processing proceeds to S108.

At S107, the address book UI unit 201 displays the corresponding cloud address books and the main body address book as a list in the selection screen 420, and receives selection of the address book from the user. Then, after the selection of the address book as a registration destination is received, the processing proceeds to S108.

At S108, the address book UI unit 201 displays a registration screen in accordance with a data management format of the address book as the registration destination. Then, the address book UI unit 201 receives an input of destination data from the user via the registration screen. An example of the screen displayed here corresponds to the registration screen 430 indicated in the UI screen 500d.

At S109, the address book control unit 202 registers the destination data input via the registration screen with the address book selected as the registration destination. In a case where the address book of the registration destination is the cloud address book, the address book control unit 202 performs registration processing by using any of interfaces of the cloud address books 210-1 to 210-4 via any of the address book connector units 203-1 to 203-4. On the other hand, in a case where the address book of the registration destination is the main body address book, the address book control unit 202 registers the destination data input via the registration screen with the main body address book storage unit 204.

As described above, in the present embodiment, the registration processing of the destination data with the cloud address book or the main body address book can be performed in the address book screen of the information processing apparatus 20. This makes it possible to manage a plurality of cloud address books by using the address book screen of the information processing apparatus as a portal without need for a user to switch registration screens for each registration destination. Therefore, even when a plurality of address books are used, operability in registration of destination data can be improved.

### Second Embodiment

A second embodiment of the present invention will be described. In SMB, FTP, WebDAV, and general cloud storage, there is a method (hereinafter, referred to as a browsing function) of browsing, designating, and operating by using a Web browser or a dedicated application screen instead of inputting an address as a transmission destination (storage location) of data by characters with a keyboard. In the present embodiment, a configuration in which browsing functions used in a screen operation of a registration screen are switched in accordance with an address book of a registration destination in destination registration processing will be described focusing on a difference from the first embodiment. The same configurations as those in the first embodiment are denoted by the same reference numbers and the description of such configurations will be omitted.

Functional Configuration

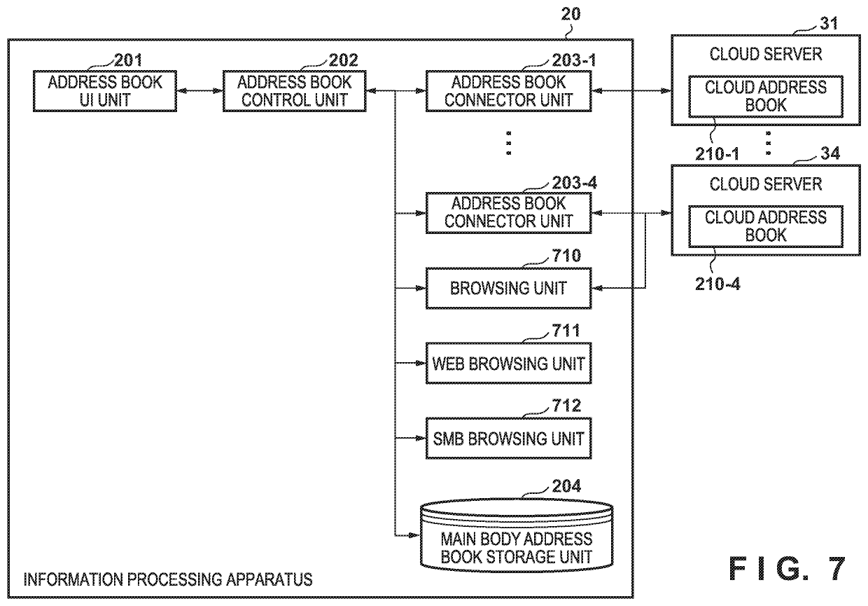

FIG. 7 is a view illustrating an example of a functional configuration of an information processing apparatus 20 according to the present embodiment. In addition to the configuration described with reference to FIG. 3 in the first embodiment, a cloud address book browsing unit 710, a Web browsing unit 711, and an SMB browsing unit 712 are provided. The cloud address book browsing unit 710 is a browsing unit that provides a browsing function corresponding to a cloud address book 210-4 of a cloud server 34. The Web browsing unit 711 is a browsing unit that provides a browsing function by a general Web browser. Specifically, the Web browsing unit 711 activates a Web browser (not illustrated), inputs a URL (Uniform Resource Locator), and traces to a specified storage location while clicking a link. The SMB browsing unit 712 is a browsing unit that provides a browsing function as represented by an explorer of a general personal computer (PC). Specifically, the SMB browsing unit 712 is a unit that advances through a folder hierarchy including a tree structure while selecting a folder displayed on a screen, and that traces to a designated storage location.

Correspondence Table

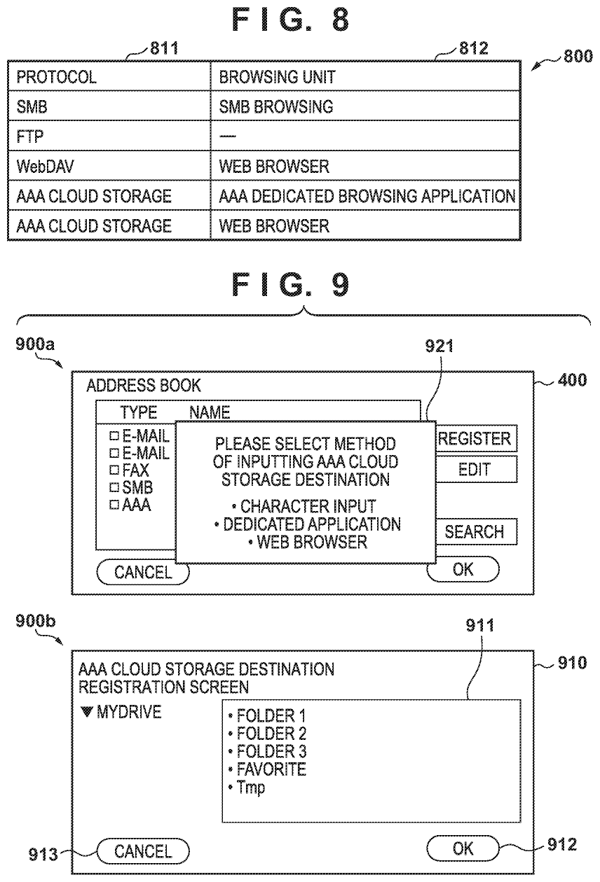

FIG. 8 illustrates an example of a browsing unit correspondence table 800 for each protocol managed by an address book control unit 202. The browsing unit correspondence table 800 includes a protocol 811 indicating a type of a transmission function and a corresponding browsing unit 812 indicating which browsing unit each protocol corresponds to.

In the example illustrated in FIG. 8, it is assumed that an “AAA cloud storage service” includes an interface by WebDAV and an interface by SOAP (Subjective Objective Assessment Plan), as Web interfaces. As for a service including a WebDAV interface, it is possible to specify a URL of the service from a general Web browser and then trace to a desired storage location while tracing a link. As for a service including a SOAP interface, a desired storage location is generally designated from a dedicated browsing application. Thus, in the example illustrated in FIG. 8, two browsing units of the “AAA dedicated browsing application” and the “Web browser” are associated as the browsing unit of the “AAA cloud storage service.” Additionally, the description will be made on the assumption that a cloud server 34 provides the AAA cloud storage service.

Address Book Screen

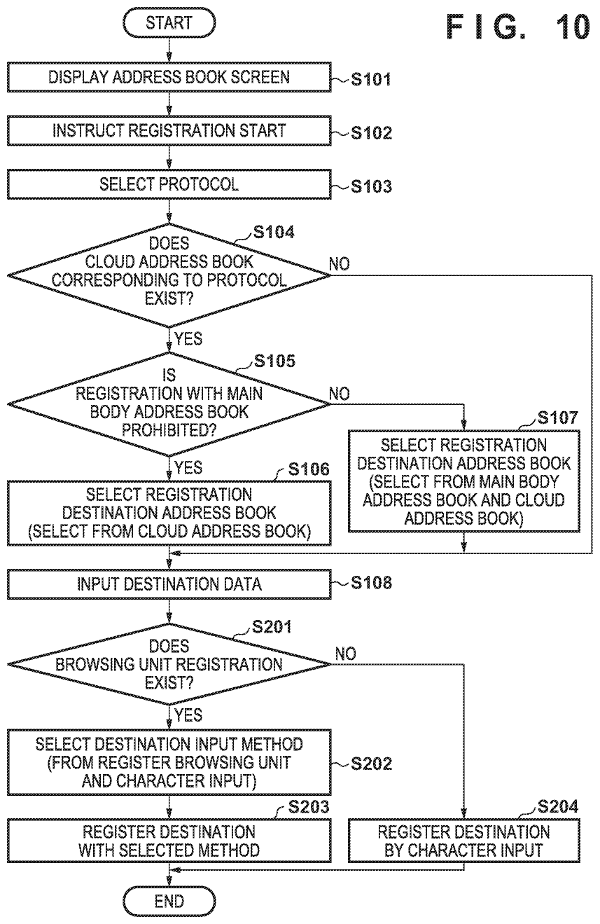

FIG. 9 is an example of an address book screen which an address book UI unit 201 of the information processing apparatus 20 according to the present embodiment displays in an operation unit 115. Since an address book screen 400, a selection screen of a protocol and an address book, and a registration screen for destination information have the same screen configuration as those illustrated in FIG. 5 of the first embodiment, the description of these will be omitted.

A selection screen 921 indicated in a UI screen 900a is a screen for a user to select a method used in the case of inputting a destination. Here, “AAA cloud storage” is selected in the selection screen 410. Contents selectably displayed in the selection screen 921 are displayed based on the browsing unit correspondence table 800. Here, as the method of inputting a destination, in addition to direct character input, a dedicated application and a Web browser defined in the browsing unit correspondence table 800 are selectably displayed.

A registration screen 910 indicated in a UI screen 900b is an example of a screen for registration with the AAA cloud storage, which is displayed in a case where the “dedicated application” is selected in the selection screen 921 indicated in the UI screen 900a. The registration screen 910 is controlled to be displayed by the address book UI unit 201, and layout information of the screen is managed by the cloud address book browsing unit 710. As described above, here, browsing is performed by the dedicated browsing application by using the SOAP interface. A list of registration destinations is displayed in a list 911. An OK button 912 is pressed in the case of confirming contents selected in the list 911. A cancel button 913 is pressed in the case of canceling selection of a registration destination.

Processing Flow

FIG. 10 is a flowchart explaining an operation performed when the information processing apparatus 20 according to the present embodiment registers destination data. This processing flow is realized by, for example, a CPU 111 of the information processing apparatus 20 that reads out and executes a program stored in a storage 114 or the like. The processing at S101 to S108 is the same as that of the first embodiment, and thus the description of this processing will be omitted.

In a case where, at S108, after destination data is input via the registration screen, the OK button is pressed, the processing proceeds to S201.

At step S201, the address book control unit 202 determines whether the browsing unit exists in the protocol to be registered, based on the information in the browsing unit correspondence table 800. In a case where the browsing unit is registered with the protocol to be registered (YES at S201), the processing proceeds to S202, and in a case where the browsing unit is not registered (NO at S201), the processing proceeds to S204.

At S202, the address book UI unit 201 displays a selection screen for selecting a destination input method, and receives a selection from a user. This corresponds to a selection operation of the input method in the selection screen 921 indicated in the UI screen 900a. As described above, the selection screen 921 indicates an example of the registration screen in a case where “AAA cloud storage” is selected in the protocol selection at S103. After the selection operation of the input method is received, the processing proceeds to S203.

At step S203, the address book UI unit 201 displays a registration screen corresponding to the input method (browsing unit or character input) selected by the user, and receives an input from the user. Specifically, the registration screen 910 indicated in the UI screen 900b is displayed, and a setting of a registration destination is received. Then, in a case where the OK button 912 is pressed after the registration destination is designated from the list 911, the address book UI unit 201 registers destination data with the designated address book via the address book control unit 202. In the case of the example of the UI screen 900b, the address book control unit 202 causes the input information to be registered with a cloud address book 210-4 of the cloud server 34 via an address book connector unit 203-4. Then, this processing flow is ended.

At S204, the address book UI unit 201 displays a destination registration screen (not illustrated) by character input, and receives an input from the user. Then, the address book UI unit 201 registers input destination data with a designated address book via the address book control unit 202. Then, this processing flow is ended.

As described above, in the case of registering destination data with a cloud address book, a browsing unit suitable for the cloud address book can be provided instead of the method using character input. Therefore, in the present embodiment, even in a case where a cloud address book including a special browsing unit is used, a plurality of cloud address books can also be managed by using an address book screen of the information processing apparatus as a portal.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-163278, filed Sep. 6, 2019 which is hereby incorporated by reference herein in its entirety.

What is claimed is:

1. A data transmission apparatus including a plurality of transmission functions each performing data transmission by using a different protocol,
the data transmission apparatus comprising:
a holding unit configured to hold an address book;
a communication unit configured to communicate with a plurality of management servers each managing a different address book;
a first management unit configured to manage each of the plurality of transmission functions in association with an address book available in data transmission among the address book held by the holding unit and the address books each provided by each of the plurality of management servers;
a second management unit configured to manage, for each of the plurality of transmission functions, a setting of whether a new destination is registrable with the address book held by the holding unit;
a providing unit configured to provide a registration screen for registering the new destination with an address book; and
a registration unit configured to perform registration processing of the new destination based on information input in the registration screen,
wherein
the registration screen switches address books as a registration destination, based on information managed by the first management unit and the second management unit, and receives an input of the new destination.

2. The data transmission apparatus according to claim 1, wherein
the setting of whether a new destination is registrable with the address book held by the holding unit is set as a detailed setting pertaining to a protocol corresponding to each of the plurality of transmission functions.

3. The data transmission apparatus according to claim 2, wherein
the setting of whether a new destination is registrable with the address book held by the holding unit is set via a Web browser operating in an external apparatus on a network.

4. The data transmission apparatus according to claim 1, wherein
the registration screen
selectably displays transmission functions as a target for registering a new destination from among the plurality of transmission functions, and
further selectably displays address books as a registration destination, in correspondence to a selected transmission function.

5. The data transmission apparatus according to claim 1, further comprising:
a plurality of browsing units each configured to provide a browsing function used in inputting destination data; and
a third management unit configured to manage each of the plurality of transmission functions in association with any of the plurality of browsing units,
wherein
the registration screen switches and displays browsing functions by the plurality of browsing units based on information managed by the third management unit.

6. The data transmission apparatus according to claim 1, comprising
a scanner configured to generate image data to be transmitted by data transmission.

7. The data transmission apparatus according to claim 1, wherein
the plurality of transmission functions include at least any of e-mail, fax, Server Message Block (SMB), File Transfer Protocol (FTP), Web-based Distributed Authoring and Versioning (WebDAV), and transmission to a cloud storage service.

8. The data transmission apparatus according to claim 1, wherein
each of the plurality of management servers is a cloud server configured to provide a cloud service for managing an address book.

9. A control method of a data transmission apparatus including a plurality of transmission functions each performing data transmission by using a different protocol, wherein
the data transmission apparatus comprises:
a holding unit configured to hold an address book;
a communication unit configured to communicate with a plurality of management servers each managing a different address book;
a first management unit configured to manage each of the plurality of transmission functions in association with an address book available in data transmission among the address book held by the holding unit and the address books each provided by each of the plurality of management servers; and
a second management unit configured to manage, for each of the plurality of transmission functions, a setting of whether a new destination is registrable with the address book held by the holding unit;
the control method comprises:
providing a registration screen for registering the new destination with an address book; and
performing registration processing of the new destination based on information input in the registration screen; and
the registration screen switches address books as a registration destination based on information managed by the first management unit and the second management unit, and receives an input of the new destination.

10. A non-transitory computer-readable recording medium storing a program that causes a computer to function as a data transmission apparatus including a plurality of transmission functions each performing data transmission by using a different protocol,
the data transmission apparatus comprises:
a holding unit configured to hold an address book;
a communication unit configured to communicate with a plurality of management servers each managing a different address book;
a first management unit configured to manage each of the plurality of transmission functions in association with an address book available in data transmission among the address book held by the holding unit and the address books each provided by each of the plurality of management servers;
a second management unit configured to manage, for each of the plurality of transmission functions, a setting of whether a new destination is registrable with the address book held by the holding unit;
a providing unit configured to provide a registration screen for registering the new destination with an address book; and
a registration unit configured to perform registration processing of the new destination based on information input in the registration screen,
wherein
the registration screen switches address books as a registration destination, based on information managed by the first management unit and the second management unit, and receives an input of the new destination.
